(19) United States
(12) Patent Application Publication
(10) Pub. No.: US 2010/0288819 A1
(43) Pub. Date: Nov. 18, 2010

(54) Method and device for connecting a cable to an electrical connection elements

(75) Inventors: Thomas Huenig, Grosswallstadt (DE); Peter Spenger, Hurden (CH); Georg Lang, Triefenstein (DE)

Correspondence Address: KANESAKA BERNER AND PARTNERS LLP, 1700 DIAGONAL RD, SUITE 310, ALEXANDRIA, VA, 22314-2848, US

(73) Assignee: TELSONIC HOLDING AG, Bronschhofen (CH)

(21) Appl. No.: 12/662,751

(22) Filed: May 3, 2010

(30) Foreign Application Priority Data
May 14, 2009 (DE) 10 2009 003 117.0

(51) Int. Cl. B23K 20/10

(52) U.S. Cl. 228/110.1; 228/1.1

(57) ABSTRACT

The invention relates to a method for connecting a cable to an electrical connection element (14), in particular a plug connector, cable shoe or similar, during which the connection elements (14) are transported successively by a transport unit (6, 7) to an ultrasonic welding device (8), each of the connection elements (14) is brought into contact with a cable end section in the ultrasonic welding device (8) and is then connected by ultrasonic welding. To increase the production speed of a cable provided with a connection element (14), it is suggested according to the invention that the next connection element (14) to be connected is transported by the transport unit (6, 7) to the ultrasonic welding device (8) during production of the ultrasonic welded connection.

The invention relates to a method as defined in the preamble of claim 1. Furthermore, it relates to a device as defined in the preamble of claim 8.

Such a method as well as such a device are offered by the company Schunk Sonosystems GmbH, D-35435 Wettenberg. With the known method, a connection element, a plug connector for example, is cut off at a regular tact from a connection element tape and is then fed to an ultrasonic welding device. There, the connection element is brought in to contact with a cable end section or cable end of a cable and is then connected by ultrasonic welding. With the known method, the production of a cable connected with a connection element takes at least 10 seconds. In actual practice, this amount of production time is considered relatively long for a connection element connected with a cable. With the device for performing the method, it is only possible to connect the connection element in one alignment with the cable end. In contrast, in actual practice, the need exists to also attach the connection element in perpendicular arrangement relative to an axis of the cable end.

An object of the invention is to eliminate the disadvantages of prior art. In particular, a method and a device are to be specified which make it possible to produce a cable provided with a connection element more quickly. A further goal of the invention is to make it possible to attach the connection element to the cable end in variable alignment by the method and the device.

This object is solved by the features of claims 1 and 8. Useful embodiments of the invention result from the features of claims 2 to 7 and 9 to 19.

According to the provisions of the invention, it is provided that, during the production of the ultrasonic welded connection, the next connection element to be connected is transported to the ultrasonic welding device by the transport unit.—Different from the prior art, the method is no longer performed at a uniform tact. In other words, in particular, regarding the transport to the ultrasonic welding device of the connection element to be connected, there is no longer a wait until the ultrasonic welded connection of the previous connection element has been completed. As a result of this, immediately after a connection element connected to a cable end is ejected, the next connection element to be connected can be placed in the ultrasonic welding device. This considerably shortens the production time for a connection element connected to a cable. In comparison to the known method in accordance with prior art, this shortens the production time by at least 30%, but usually by more than 50%.

In the sense of this invention, “cable” is used as a general term. In particular, it also contains a strand, a flat conductor, a ribbon cable, an enameled wire, a wire, a braided strand or similar.

In an advantageous embodiment of the invention, the connection elements are cut off from a connection element tape by a cutting device before being taken by the transport unit. The connection element tape can be held on a reel like a film spool. In doing so, the connection elements can be connected successively with each other by material bridges made of copper, for example. These material bridges can then be cut by the cutting unit to separate them into single pieces. It goes without saying that it is also possible that the connection elements are already available in single pieces and, for example, are fed via a cartridge or similar to the transport unit.

In a further advantageous embodiment of the invention, each of the connection elements is transported to the ultrasonic welding device by a first transport means of the transport unit during the production of the ultrasonic welded connection. In other words, the connection element is transported section by section by the first transport means along a specified path to the ultrasonic welding device. For this purpose, the first transport means can, for example, be provided with a gripping unit with which the connection element is gripped and is then moved along the specified transport path. The provision of a gripping unit permits particularly precise alignment of the connection element.

In a further advantageous embodiment, the connection element can be transferred from the first transport means to a second transport means of the transport unit. The second transport means is usefully connected to a source of vacuum. The connection element can be held on the second transport means by vacuum.

In a particularly advantageous embodiment of the invention, the transfer to the second transport means can take place during or after the production of the ultrasonic welded connection. This enables a further shortening of the production time of a connection element connected to a cable end. The connection element can be transported to the immediate vicinity of the ultrasonic welding device at the same time as the ultrasonic welded connection is being produced. This can shorten the time for the transport of the connection element to the ultrasonic welding device and, overall, drastically reduce the production time for a connection element connected to a cable end.

In a further particularly advantageous embodiment of the invention, the connection element is swiveled by means of the first transport means by a specified angle, preferably 80 to 100°, and is then transferred to the second transport means. The second transport means transports the connection element in the accordant swiveled state to the ultrasonic welding device. There it is connected in the accordant swiveled state to the cable end by ultrasonic welding. The suggested version of the method makes it simple and inexpensive to attach the connection element in different alignments relative to an axis of the cable end.

Furthermore, it has been shown to be useful that the connection element is transported by the second transport means in at least one horizontal direction, preferably two horizontal directions running essentially vertically to each other, and one vertical direction. The design of the second transport means is thus particularly universal and permits a transport of the connection element even under different circumstances or embodiments of the ultrasonic welding device.

According to the device-side provisions of the invention, it is provided that a control for controlling the transport unit and the ultrasonic welding unit is configured such that, during the production of the ultrasonic welded connection, the next connection element to be connected is transported to the ultrasonic welding device by the transport unit.—The above mentioned advantages can be achieved with this.

The term “control” is used to mean a conventional, suitable control for the implementation of automated motion routines. This is a process computer, for example, which is provided with a suitable program. The control can comprise sensors for monitoring of a correct position or final position of transport means of the transport unit. In this connection, the transport means can be operated pneumatically, electrically or hydraulically. With the transport unit, this can also be a robot arm, for example, with which a connection element is gripped and is then placed in the ultrasonic welding device.

In advantageous arrangement, a cutting device is provided upstream from the transport unit for cutting off the connection elements from a connection element tape. With the cutting device, this can be scissors, for example, with which the connection elements are sheared off successively from the connection element tape.

In advantageous arrangement, the transport unit comprises a first transport means and the control is configured such that the connection element can be transported to the ultrasonic welding device during the production of the ultrasonic welded connection. Moreover, the transport unit can comprise a second transport means and the control can be configured such that the connection element is transferred from the first transport means to the second transport means. In this connection, the control can furthermore be configured such that the transfer to the second transport means takes place during or after the production of the ultrasonic welded connection.

With the first and second transport means, these are usefully separately controllable actuators or groups of actuators. The control of such actuators or actuator groups can be performed in an open or closed control loop.

In an advantageous embodiment, the first transport means comprises a swiveling device by which the connection element can be swiveled by a specified angle, preferably 80 to 100°, particularly preferred 90°, before the transfer to the second transport means. This permits the attachment of one and the same connection element to the cable end in different alignments.

For the transport of the connection element, the second transport means can comprise at least one, preferably two, means of linear motion for the transport in one horizontal direction, preferably two horizontal directions running essentially vertical to each other, and one means of vertical motion. The means of linear motion and/or the means of vertical motion can comprise hydraulic, electrical or pneumatic actuators.

In a further particularly advantageous embodiment of the invention, the sonotrode of the ultrasonic welded connection is provided with a coating made of diamond or an insert made of polycrystalline diamond. The coating made of diamond can be made of polycrystalline diamond. Such a coated sonotrode permits the production of a ultrasonic welded connection of the connection element to a cable essentially made of aluminum. The insert can be connected to the sonotrode by a soldered connection, for example.

In a further particularly advantageous embodiment, the device according to the invention is set up modularly. In particular, the ultrasonic welding unit can be configured as an exchangeable first module. In case of a failure of the ultrasonic welding unit, this can be quickly replaced. Undesired device down times can thus be minimized.

The first transport means can also be configured as an exchangeable second module. The second transport means can be configured as an exchangeable third module. Finally, the cutting device can be configured as an exchangeable fourth module. Also here, the suggested modular setup of the device permits a considerable simplification of repair measures and thus a minimization of down times in case one of the modules fails.

An example will now be used to describe the invention in more detail based on the drawings. The figures are listed below:

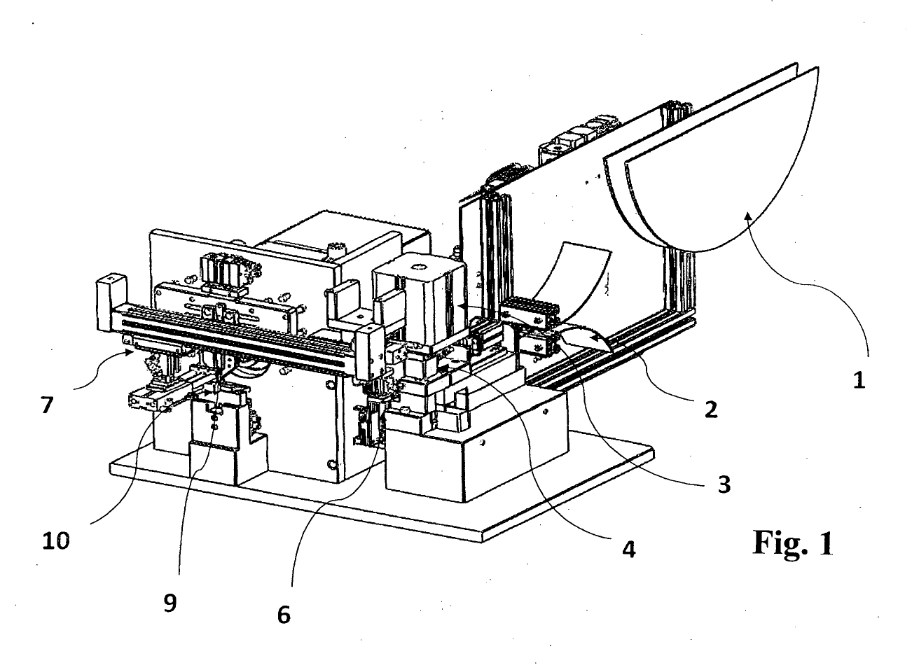

FIG. 1 a partial broken up view in perspective of a device,

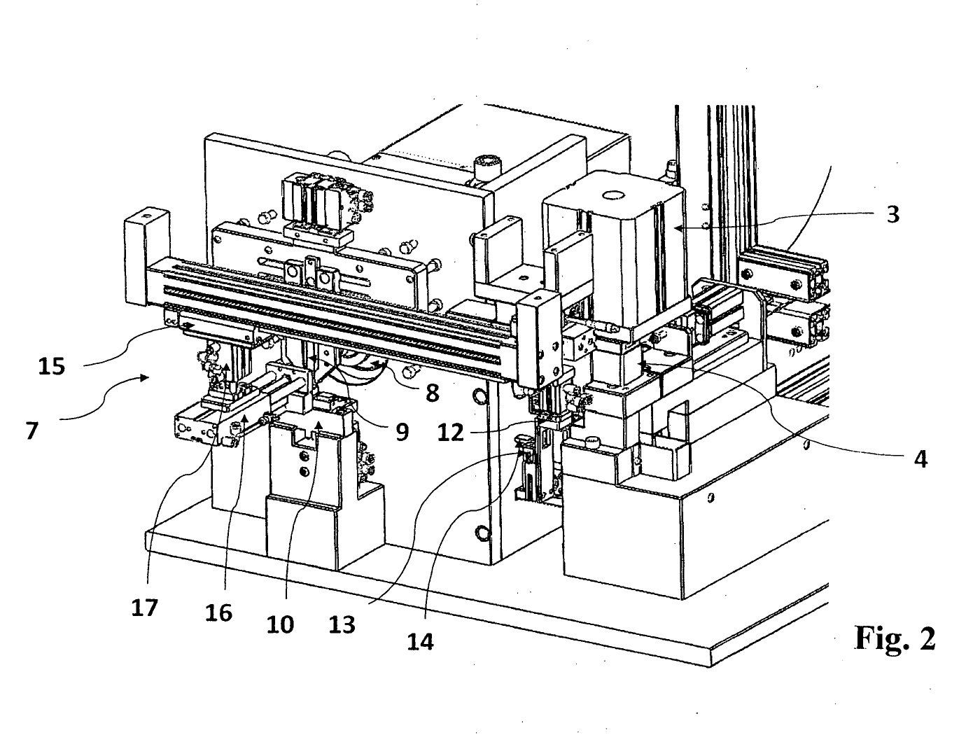

FIG. 2 an enlarged partial view as per FIG. 1,

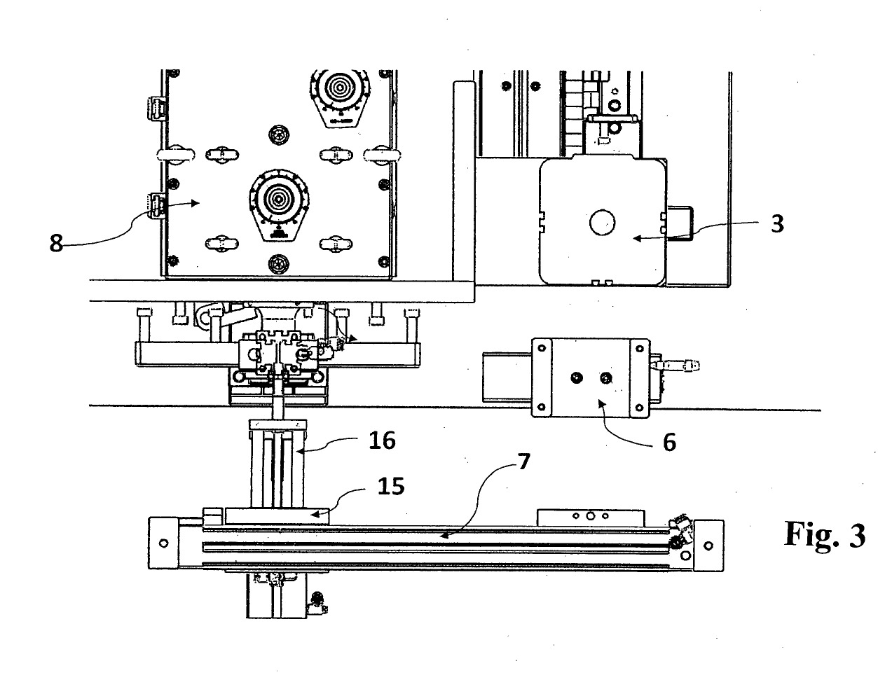

FIG. 3 a top view as per FIG. 2,

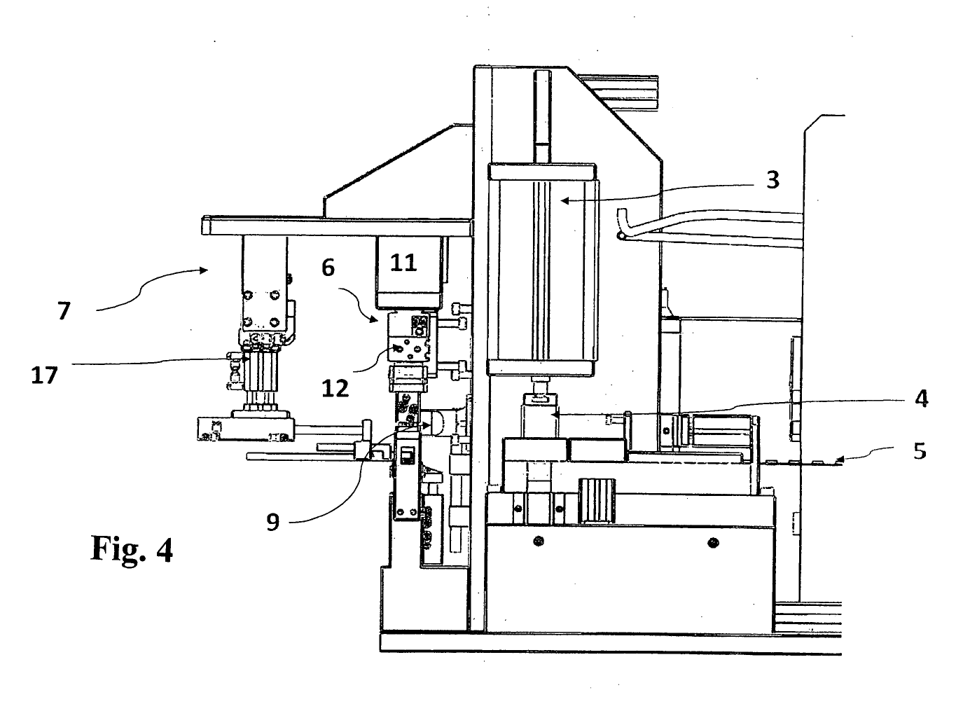

FIG. 4 a partial side view of the device,

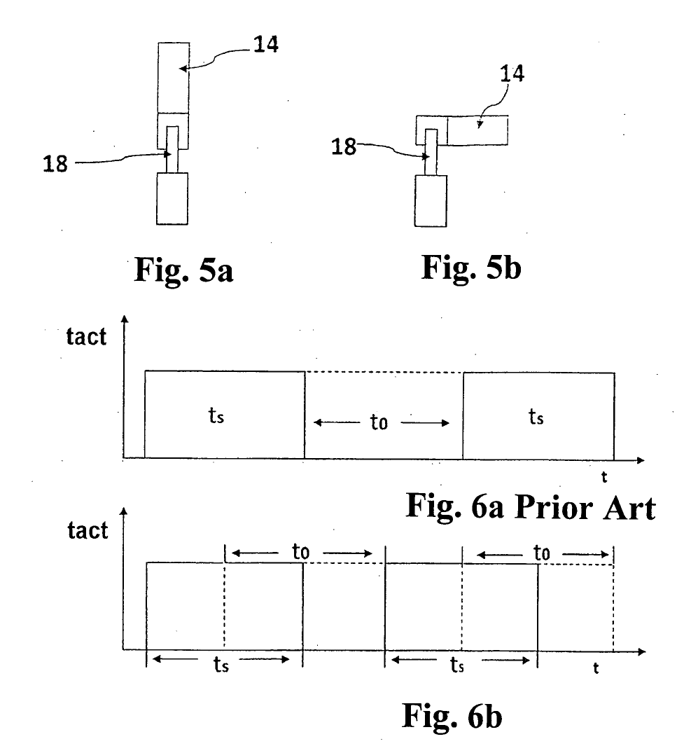

FIGS. 5a, 5b top views of connection elements connected with a cable end,

FIG. 6a a tact sequence in accordance with prior art and

FIG. 6b a tact sequence in accordance with the present invention.

FIG. 1 shows an only partially represented reel with the reference sign 1 on which a connection element tape (not shown here) made up of connected connection elements can be held. Downstream from the reel 1, a guide 2 is provided with which a connection element tape 5 (see FIG. 4) is fed to a cutting device 4. A first transport means generally designated with the reference sign 6 as well as a second transport means generally designated with the reference sign 7 are provided downstream from the cutting device 4—as is particularly clearly shown in FIG. 3. A ultrasonic welding device generally designated with the reference sign 8 comprises a sonotrode 9 and an anvil 10 located opposite.

As is particularly shown in FIG. 4, the first transport means 6 comprises a swivel unit 11 by which a holder element 12 can be swiveled by an angle of +/−90°. A first gripping unit designated with the reference sign 13 can be operated, for example, pneumatically. Reference sign 14 designates a connection element which is held by clamping with the first gripping unit 13 (see FIG. 2).

The second transport means 7 comprises a first linear motion unit 15 as well as a second linear motion unit 16. A vertical motion unit is designated with the reference sign 17.

FIG. 5a shows a top view of a connection element 14 which is connected to a cable end section 18 in a first alignment. In this connection, the connection element 14 is aligned approximately parallel with an axis of the cable end section 18. With the embodiment shown in FIG. 5b, the connection element 14 is, in contrast, attached to the cable end section 18 at an angle of approximately 90°.

The function of the device is as follows:

The connection element tape 5 is fed via the guide 2 to the cutting unit 4. The feed is performed by a feeder unit (not shown here) which is controlled by a control (also not shown here). Using the cutting unit 4, consecutive connection elements 14 are cut off from the connection element tape 5. Then the cut off connection elements 14 are each gripped by the gripping unit 13 of the first transport means 6 and, if desired, placed at an angle position specified by the control by the swivel unit 11. While this procedure is taking place, a further connection element is located in the ultrasonic welding device 8 which element is welded to a cable end (not shown here) at the same time. During the ultrasonic welding procedure, the second transport means 7 can move in the direction of the first transport means 6. The first 15 as well as the second means of linear motion 16 and the means of vertical motion 17 are controlled by the control in such a manner that, by the second transport means 7, the connection element 14 is suctioned with a suctioning device provided thereon (not shown here) and is then taken over by the first transport means 6. In this connection, the alignment of the connection element 14 specified by the angle position of the gripping unit 13 is retained.

Afterwards, the connection element 14 is transported to the ultrasonic welding device 8 by the second transport means 7 and, after ejection of a further connection element connected to a cable end before, is placed between the sonotrode 9 and the anvil 10. There it is brought into contact with a cable end to be connected (not shown here) and is then welded to the cable end by the ultrasonic welding device 8. During this procedure, a subsequent connection element is moved in the direction of the ultrasonic welding device 8 by the first 6 and/or second transport means 7.

FIG. 6a shows the tact sequence of welding tacts tₛ and intermediate tacts t₀ in accordance with prior art. Here, an intermediate tact t₀ following each welding tact tₛ is just as long as a welding tact tₛ. During the intermediate tact t₀, the next connection element 14 to be connected is cut off from the connection element tape 5 and is transported to the ultrasonic welding device 8.

FIG. 6b shows the tact sequence of the welding tacts tₛ and the intermediate tacts t₀ as per this invention. From this it is evident that, according to the invention, the intermediate tact t₀ is partially overlaid by the welding tact tₛ. By moving the next consecutive connection element in the direction of the ultrasonic welding device 8 at the same time an ultrasonic welded connection is made, the production of cables provided with connection elements 14 can be considerably accelerated.

### LIST OF REFERENCE SIGNS

1 Reel
2 Guide
3 Pressure cylinder
4 Cutting device
5 Connection element tape
6 First transport means
7 Second transport means
8 Ultrasonic welding device
9 Sonotrode
10 Anvil
11 Swivel unit
12 Holder element
13 Gripping unit
14 Connection element
15 First means of linear motion
16 Second means of linear motion
17 Means of vertical motion
18 Cable end section

1. Method for connecting a cable to an electrical connection element (14), in particular a plug connector, cable shoe or similar, during which the connection elements (14) are transported successively by a transport unit (6, 7) to an ultrasonic welding device (8), each of the connection elements (14) is brought in contact with a cable end section of a cable in the ultrasonic welding device (8), and is then connected by ultrasonic welding,
characterized in that
the next connection element (14) to be connected is transported to the ultrasonic welding device (8) by the transport unit (6, 7) during the production of the ultrasonic welded connection.

2. Method as defined in claim 1, wherein the connection elements (14) are cut off from a connection element tape (5) by a cutting device (3, 4) before being taken by the transport unit (6, 7).

3. Method as defined in claim 1, wherein each of the connection elements (14) is transported to the ultrasonic welding device (8) by a first transport means (6) of the transport unit during the production of the ultrasonic welded connection.

4. Method as defined in claim 1, wherein the connection element (14) is transferred from the first transport means (6) to a second transport means (7) of the transport unit.

5. Method as defined in claim 1, wherein the transfer to the second transport means (7) takes place during or after the production of the ultrasonic welded connection.

6. Method as defined in claim 1, wherein the connection element (14) is swiveled by means of the first transport means (6) by a specified angle, preferably 80 to 100°, and is then transferred to the second transport means (7).

7. Method as defined in claim 1, wherein the connection element (14) is transported by the second transport means (7) in at least one horizontal direction, preferably in two horizontal directions running essentially vertically to each other, and one vertical direction.

8. Device for connecting a cable to an electrical connection element (14), in particular a plug connector, cable shoe or similar, comprising
a transport unit (6, 7) for successively transporting the connection elements (14) to an ultrasonic welding device (8) and
an ultrasonic welding device (8) for connecting each of the connection elements (14) to a cable end section of a cable by ultrasonic welding,
characterized in that
a control for controlling the transport unit (6, 7) and the ultrasonic welding device (8) is configured such that, during the production of the ultrasonic welded connection, the next connection element (14) to be connected is transported to the ultrasonic welding device (8) by the transport unit (6, 7).

9. Device as defined in claim 8, wherein a cutting device (3, 4) is provided upstream from the transport unit (6, 7) for cutting off the connection elements (14) from a connection element tape (5).

10. Device as defined in claim 8, wherein the transport unit (6, 7) comprises a first transport means (6) and the control is configured such that the connection element (14) can be transported to the ultrasonic welding device (8) during the production of the ultrasonic welded connection.

11. Device as defined in claim 8, wherein the transport unit (6, 7) comprises a second transport means (7) and the control is configured such that the connection element (14) is transferred from the first transport means (6) to the second transport means (7).

12. Device as defined in claim 8, wherein the control is configured such that the transfer to the second transport means (7) takes place during or after the production of the ultrasonic welded connection.

13. Device as defined in claim 8, wherein the first transport means (6) comprises a swivel unit (11) by which the connection element (14) can be swiveled by a specified angle, preferably 80 to 100°, before the transfer to the second transport means (7).

14. Device as defined in claim 8, wherein the second transport means (7) for the transport of the connection element (14) comprises at least one, preferably two, means of linear motion (15, 16) for the transport in one horizontal direction, preferably two horizontal directions running essentially vertical to each other, and one means of vertical motion (17).

15. Device as defined in claim 8, wherein a sonotrode (9) of the ultrasonic welding device (8) is provided with a coating made of diamond or an insert made of polycrystalline diamond.

16. Device as defined in claim 8, wherein the ultrasonic welding unit (8) is configured as an exchangeable first module.

17. Device as defined in claim 8, wherein the first transport means (6) is configured as an exchangeable second module.

18. Device as defined in claim 8, wherein the second transport means (7) is configured as an exchangeable third module.

19. Device as defined in claim 8, wherein the cutting device (3, 4) is configured as an exchangeable fourth module.
